(19) United States
(12) Patent Application Publication
(10) Pub. No.: US 2014/0324619 A1
(43) Pub. Date: Oct. 30, 2014

(54) REVERSE AUCTIONS FOR TRADE ITEMS

(71) Applicant: Daniel M. CHAMBERS, Solana Beach, CA (US)

(72) Inventor: Daniel M. CHAMBERS, Solana Beach, CA (US)

(21) Appl. No.: 14/218,962

(22) Filed: Mar. 18, 2014

Related U.S. Application Data
(63) Continuation-in-part of application No. 14/217,458, filed on Mar. 17, 2014.
(60) Provisional application No. 61/802,632, filed on Mar. 16, 2013.

(51) Int. Cl. G06Q 30/08

(52) U.S. Cl. CPC G06Q 30/08
USPC 705/26.3

(57) ABSTRACT

The present invention concerns computer-based methods and systems for performing buyer-initiated reverse auctions to purchase consumer products and services. The invention allows a prospective buyer who commits to purchase a particular consumer good or service for not more than a buyer-specified price to initiate a reverse auction online amongst accredited vendors of the consumer product or service in order to purchase the product or service on terms at least as favorable as initially specified by the buyer. In a preferred embodiment, a computer system according to the invention includes a network computer that receives particular product/service descriptions and buyer-specified price ceilings from financially committed buyers. The system then initiates a reverse auction amongst accredited potential vendors who bid against one another in an effort to secure the sale. Upon the auction's closing, the accredited vendor that offered the most favorable terms to the buyer is awarded the sale. The vendor is then paid and the product or service delivered or provided to the buyer. The present invention will revolutionize commerce by empowering buyers to purchase products and services at or below prices they determine.

### RELATED APPLICATIONS

This application claims the benefit of and priority to U.S. provisional patent application Ser. No. 61/802,632 (attorney docket no. DMC-1010-PV) and U.S. provisional patent application Ser. No. 14/217,458 (attorney docket no. DMC-1010-UT), the contents of which are hereby incorporated by reference for any and all purposes.

### FIELD OF THE INVENTION

This invention concerns buyer-initiated reverse auctions conducted over computer networks.

### BACKGROUND OF THE INVENTION

1. Introduction

The following description includes information that may be useful in understanding the present invention. It is not an admission that any such information is prior art, or relevant, to the presently claimed invention, or that any publication specifically or implicitly referenced is prior art.

2. Background

Today in the U.S., consumer spending accounts for more than 70% of the country's almost $16 trillion economy. In this free market-based system, almost all buyer-vendor interactions are vendor-oriented in that they are based on methods and processes that allow vendors to price, package, and configure goods and services to their advantage. In-store displays, online, print, radio, and television advertisements, telemarketing, auctions (including online auction services such as eBay), are all vendor-initiated and used to attract buyers.

As consumers are well aware, most goods and services sold at retail rely on a business model wherein a vendor sets a price and a buyer decides whether or not to accept that vendor-determined, non-negotiable fixed price. Of course, transactions for some goods and services involve negotiations between buyers and vendors over various terms of sale, particularly the purchase price to be paid.

Auctions are another business model available to vendors of goods and services, although in conventional forward auction systems, final sales prices are not fixed by a vendor. Instead, final sales prices are determined by attracting numerous potential buyers for the particular good or service who, as a group, determine the final selling price through a competition in which interested buyers make escalating bids as to the final sales price to be paid. Unless the auction is one wherein the vendor has established a “reserve” price (i.e., the lowest bid price that the vendor will accept and which, if not reached, allows the vendor to subsequently reject any or all bids submitted during the auction, the result of which is that the product remains unsold), the product or service is sold to the highest bidder during the auction period. Vendors using traditional auction houses, as well as online auction house such as eBay, employ this centuries' old business model.

Business models in which a single buyer solicits multiple potential vendors are also known. Such buyer-driven models include “wanted” advertisements, whereby a buyer advertizes for a good or service s/he/it wishes to purchase from anyone capable of supplying that good or service.

Another example of a buyer-driven model is Priceline's NAME YOUR OWN PRICE® online service, whereby a consumer interested in purchasing airline tickets or hotel accommodations or renting a car enters a price s/he is willing to pay (in addition to other information, such as date ranges for travel, etc.) along with a commitment to pay if her/his price is accepted. After confirming that the prospective buyer has the funds available, the buyer's offer is then circulated to participating airlines, hoteliers, and/or rental car companies, as the case may be, to solicit acceptances and/or counteroffers. To date, however, such buyer-directed non-auction business models do not allow a buyer to optimize the terms of, particularly the price for, a particular purchase of a new good or service the buyer wishes to purchase; instead, such models merely seek to allow a buyer to identify a prospective vendor willing and able to provide the desired good or service at the buyer's specified price. Once such a vendor is identified, the buyer purchases the good or service from that vendor at the agreed price.

Still other examples of buyer-driven models are used by large organizations (e.g., companies or governments) that want to purchase large quantities of goods or services at the lowest possible price. To begin, the buyer formulates a non-binding “request for proposal” (RFP) or “request for quote” (RFQ), i.e., a detailed written specification setting forth the quantities, requirements, and specifications of what is desired to be purchased. Once finalized, RFPs (or RFQs) are then distributed to a list of known potential suppliers, and perhaps others, for example, by publishing the RFP (or RFQ) in trade journals or other sources available frequented by potential suppliers. Potential suppliers that become aware of the RFP/RFQ then determine if they wish to respond by submitting a formal proposal or quote, i.e., a legal binding offer to fulfill the request for the goods or services. Often, two or more potential suppliers respond with binding offers, which the buyer then evaluates. If at least one is acceptable to the buyer, it notifies the supplier that submitted the most preferred offer to the buyer that it “won” the business reflected in its binding offer. Such notice, if received before an offer expires or is rescinded or modified, constitutes acceptance, which, along with consideration (e.g., payment), forms a legally binding contract between the buyer and the “winner”. See, e.g., U.S. Pat. No. 5,794,207.

Large organizations can benefit from the RFP/RFQ process because their volume buying represents a worthwhile opportunity for potential suppliers to compete for their business. They also have the resources to communicate their buying needs to a sufficient number of potential suppliers to ensure that at least one, and preferably several, respond with a binding proposal. As a result, a large organization can often achieve substantial unit cost savings, especially on commodity products or services.

On the other hand, individual consumers historically have been unable to utilize the RFP/RFQ process, as they generally lack the buying power and resources of large organizations. This invention addresses those failings.

### DEFINITIONS

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

An “accredited vendor” refers to a party having an existing retail or wholesale business that stocks, sells or provides, advertizes or offers to sell or provide, delivers, and/or can have delivered or provided without backorder the target product or service.

An “auction period” refers to a buyer- or system-defined time period during which a reverse auction (preferably conducted online) takes place. Such periods include optionally include those are from about 1-360 minutes, about 1-72 hours, about 1-60 days, or about 1-6 months.

A “consumer product” or service is a product or service that is intended to be purchased for consumption by the average consumer. Consumer goods are the end result of production and manufacturing and are what a consumer sees on the store shelf or other point of sale. Clothing, food, automobiles, and jewelry are all examples of consumer goods. Basic materials such as copper are not considered consumer goods because they must be transformed into usable products. A “consumer product bundle” or “bundle of consumer products” refers to two or more consumer products grouped together by a prospective buyer in the context of a single reverse auction. Each product or service combined in such a “bundle” can be identified by a descriptor or descriptor set unique for that product or service.

A “descriptor” or “descriptor set” for a product or service refers to data or information that allows the target product or service to be distinguished from all other non-target products or services. A representative example of such a target product or service descriptor is the Universal Product Code (UPC), which uses a well-known barcode symbology widely utilized in Canada and the U.S. for inventory tracking of goods in stores, warehouses, etc. Other examples include EAN (International Article Number) barcodes used worldwide for marking products often sold at retail points of sale. UPC, EAN, and other Global Trade Item Numbers (GTINs) are trade item identifiers that uniquely and universally allow a particular trade item type to be identified in a database and distinguished from all other trade items in the same or another database. Other exemplary trade item descriptors are descriptor sets made up of several different types of data or information, such as catalog or part numbers, product names, and the like, often combined with other information such as manufacturer name.

A “system-derived descriptor analog” refers to a descriptor that is generated, preferably automatically by a computer, from buyer-specified data. For example, if a buyer inputs as a trade item descriptor a the name of product and its manufacturer, a computer can search for and identify the corresponding UPC code, which may then be used instead of or in addition to the descriptive information for trade item in the buyer-specified data.

A “financially committed buyer” refers to a buyer that has made funds irrevocably available to purchase a particular target product or service in the event of a closing for a reverse auction conducted in accordance with the invention for such product or service.

A “patentable” process, machine, or article of manufacture according to the invention means that the invention as claimed satisfies all statutory requirements for patentability at the time the particular analysis is performed. For example, with regard to novelty, non-obviousness, or the like, if post-issuance investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards for assessing whether a particular statutory requirement for patentability is satisfied change from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

A “purchase order” is an electronic or written record or writing that constitutes a contractual offer the acceptance of which, along with the specified consideration, results in the formation of a legally binding contract.

A “reverse auction” refers to an auction system wherein price-optimized acceptance of a financially committed buyer's purchase offer for a target product or service is solicited from a plurality of accredited vendors of the target product or service. Price-optimized acceptance is achieved by allowing the solicited accredited vendors to participate in an online auction in which bids are sorted by purchase price, and the winning bid is selected as the lowest purchase price submitted, or, if two or more bids of the same purchase price are submitted, the bid that is most favorable to the buyer with regard to at least one other o criterion (e.g., delivery date, vendor location, vendor size, vendor identity, etc.).

A “target product or service” refers to a new good or a service, particularly a new consumer product or service, that a buyer wishes to acquire, typically by purchase, although leasing, rental, and other transactions involving defined payment terms are also envisioned.

A “trade item” refers to any product or service that may be priced, ordered, invoiced, or retrieved at any point in any supply chain.

### SUMMARY OF THE INVENTION

The present invention allows consumers to optimize the terms, particularly the purchase price, of transactions for new products and services, including consumer products and/or services and/or other trade items. In so doing, since the purchase price for a good or service is often the primary determinant as to not only whether a consumer will purchase a particular good or service at all but also as to how s/he may subsequently feel about the purchase (e.g., does s/he feel “good” about the purchase, does the buyer regret the purchase, did the buyer receive good “value” from the purchase, etc.), the invention will increase the likelihood of a consumer purchasing a target product or service, minimize the financial cost to the consumer of purchasing target products or services, and empower the consumer by enhancing the consumer's emotional response to the purchase.

Thus, one aspect the invention concerns reverse auction methods that allow for purchase price optimization from a buyer's perspective. Such methods utilize computers, and are preferably Internet or web-based online systems. The methods involve providing to a computer buyer-specified data that includes (i) at least one descriptor for a target product or service that allows the target product or service to be distinguished from all other non-target products or services and (ii) a ceiling purchase price for the target product or service. The buyer-specified data is used to generate a buyer's purchase offer for target trade item the buyer wishes to purchase. The buyer's purchase offer may or may not include a purchase price specified by the buyer or the system conducting the reverse auction.

The instant methods also involve providing a payment indicator that evidences irrevocable availability of funds associated with the buyer in an amount sufficient to pay the buyer's ceiling purchase price if a closing occurs for a reverse auction corresponding to the purchase order. The buyer's ceiling purchase price is preferably not disclosed to vendor(s) and, in some embodiments, no purchase price information from the buyer is disclosed to any vendor(s) during a reverse auction. Additionally, the methods include an auction identifier so that the particular reverse auction corresponding to the purchase offer and payment indicator can be identified.

After obtaining the auction identifier, using the computer system initiates a reverse auction that corresponds to the purchase offer and payment indicator. The reverse auction has a defined auction period, which can be specified by the buyer, set by the system, or otherwise be specified in any suitable manner. The auction period optionally may be extended for one or more defined periods in the event of continued bidding activity just prior to closing of the auction.

The system initiates the reverse auction by making a binding buyer's purchase offer available to at least one accredited vendor, preferably by posting the buyer's purchase offer online. The buyer's purchase offer includes at least one of the trade item descriptors from the buyer-specified data (and/or system-derived descriptor analog therefore) and a trade item purchase price equal to or less than the buyer's ceiling purchase price. If desired, the system may also contact one or more accredited vendors of the trade item this is the subject of the reverse auction in order to apprise such vendor(s) of the reverse auction. Such contact can be made by any suitable modality, including email, text message, telephone, and/or fax, and can include information such as the auction identifier, the start and/or scheduled end time for the auction, the target trade item that is the subject of the auction, the buyer's ceiling purchase price, and/or such other information as the buyer and/or party controlling the computer system wishes to include.

During the auction period any accredited vendor aware of the reverse auction has the option to place one or more qualified bids intended to result in acceptance of the buyer's purchase offer. To proffer acceptance of the buyer's purchase offer, an accredited vendor must indicate at least a selling price equal to or less than the trade item purchase price. A vendor's proffered acceptance may also provide further agreements, commitments, information, and/or undertakings on the part of the vendor, for example, a commitment to deliver the target trade item upon receipt of payment of the final sales price, or, in some instances, a final transaction price, which is the sum of the final sales price and such other additional costs or expenses the buyer has agreed to bear, whether pursuant to the terms of the buyer's purchase offer or otherwise. Such other additional costs or expenses may include applicable sales and/or use taxes, shipping and delivery charges, insurance, extended warranties and/or service plans, etc.

If no accredited vendor proffers acceptance (i.e., a commitment to provide the target trade item on terms that at least meet those of the buyer's purchase offer) during the auction period, the auction may be closed or extended for one or more additional defined periods if approved by the buyer, in which event the accredited vendor(s) from whom acceptance was earlier solicited may be informed of such extension(s). If one accredited vendor proffers acceptance during the auction period, the auction is closed at the conclusion of the auction period, the final sales price is fixed as the selling price for the target product or service, and sale of the target product or service is awarded to such accredited vendor. If more than one accredited vendor proffers acceptance during the auction period, the auction is closed at the conclusion of the auction period, the sale of the target product or service (or other trade item) is awarded to the accredited vendor that first proffered acceptance during the auction on terms most favorable to the buyer, and the selling price proffered by the accredited vendor awarded the sale is fixed as the final sales price; alternatively, if two or more accredited vendors proffer acceptance just prior to the end of the auction period that, in the absence of the other proffered acceptance(s), would have won the auction for such accredited vendor, the auction period may be extended for one or more additional defined periods if approved by the buyer, in which event the accredited vendor(s) from whom acceptance was earlier solicited, or a subset of such vendors, may be informed of such extension(s), with the auction being closed at the end of any such permitted extension(s). If a vendor elects not to participate in bidding during an extension, such vendor will be precluded from winning the reverse auction.

As an alternative to closing the auction if no accredited vendor proffers acceptance during the auction period, if agreed by the buyer before or during the auction period the buyer's purchase offer then in effect may be revised to include a revised trade item purchase price greater than the trade item purchase price being replaced but equal to or less than the ceiling purchase price. Yet other alternative embodiments involve allowing such an auction to close without an acceptance and initiating a new auction according to the invention using either the same, or preferably a revised, trade item purchase price greater than the trade item purchase price from the immediately preceding auction but equal to or less than the ceiling purchase price specified in the buyer's purchase order.

If there is an acceptance during the auction period (or an extension thereof), the methods of the invention can also include so informing the buyer, preferably also then informing the buyer of the final sales price for the target trade item, facilitating the winning vendor's collection of payment of the final sales price, and/or facilitating delivery or provision of the target trade item to the buyer.

In other embodiments, the methods of the invention concern reverse auctions wherein the buyer's purchase offer does not include a trade item purchase price as a guide to assist prospective vendors in deciding whether or not participate in a particular reverse auction according to the invention.

In other embodiments, the methods of the invention include in the buyer's purchase offer a buyer-specified or approved SELL IT NOW™ price that is equal to or less than the buyer's ceiling purchase price (or other price information provided by or on behalf of the buyer to prospective vendor(s) participating in a particular reverse auction). In such embodiments, if at any point during the auction period or term, or, alternatively, during a pre-bidding preview period preceding the bidding period of the auction period, a vendor (preferably an accredited vendor) proffers acceptance by agreeing to sell the target product or service to the buyer at the SELL IT NOW™ price, the auction is then closed, the SELL IT NOW™ price is fixed as a final sales price, and the sale is awarded to the accredited vendor that agreed to complete the sale at the SELL IT NOW™ price.

Other embodiments of this aspect relate to optimizing a reverse auction when more than one accredited vendor proffers acceptance during the auction period. In some of these embodiments, prior to closing the auction at the conclusion of the auction period, at least the accredited vendor who proffered an acceptance that included the second (or higher) lowest selling price during the auction period is (are) apprised that at least one other vendor proffered the same or lower selling price and is (are) offered the opportunity to downwardly revise its (their) respective selling price(s), if desired. In others, prior to closing the auction at the conclusion of the auction period, every accredited vendor other than the accredited vendor that proffered the lowest selling price is (i) apprised that another accredited vendor participating in the same reverse auction has proffered acceptance at a selling price less than such apprised vendor's respective selling price and (ii) allowed to downwardly revise its respective proffered selling price, if desired. In such embodiments, if an accredited vendor downwardly revises its selling price such that at the conclusion of the auction period (or any extension thereof) it first proffered acceptance on terms most favorable to the buyer, the auction is closed, the final sales price is fixed at the downwardly revised selling price provided by such accredited vendor, and the sale is awarded to such accredited vendor. If a vendor wishes to rescind its proffered acceptance prior to the end of an auction period (or any extension thereof), the system may be so configured. Similarly, in some embodiments, a buyer is able to cancel or terminate a reverse auction prior to its initiation or during the auction term, provided that a prospective vendor has not proffered an acceptance that would have otherwise won the auction had it been allowed to run until the end of the applicable auction period.

Another aspect of the invention concerns computer systems configured to allow the reverse auction methods of the invention to be carried out thereon. Such systems include, in operable association, a power supply, one or more processors configured to execute computer control logic to perform a reverse auction in accordance with the instant invention, one or more computer interfaces that allow receipt of the data and information required to be provided by the buyer in order to complete the buyer's purchase order for the target product or service as well as the information or data required to be provided by each accredited vendor in order to complete such vendor's proffered acceptance, and one or more storage devices for storing data at least some of which is received through one more interfaces and at least some of the computer control logic used to perform the reverse auction.

Related aspects of the invention concern computer control logic for directing a computer to perform the reverse auction methods of the invention, as well as computer program products and memory devices embodying computer control logic.

Various features and advantages of the invention will appear from the following description in which the preferred embodiments have been set forth in detail in conjunction with the accompanying drawings.

### DETAILED DESCRIPTION

### 1. Introduction

As those in the art will appreciate, the following detailed description describes certain preferred embodiments of the invention in detail, and is thus only representative and does not depict the actual scope of the invention. Before describing the present invention in detail, it is understood that the invention is not limited to the particular aspects and embodiments described, as these may vary. It is also to be understood that the terminology used herein is for the purpose of describing particular embodiments only, and is not intended to limit the scope of the invention defined by the appended claims.

### 2. Contract Law Primer

Forming a legally binding contract requires three elements: offer; acceptance; and consideration. Thus, mutual manifestation of assent by each the buyer and seller (i.e., vendor) to the same terms is essential, and is established by a process of offer and acceptance. Further legal requirements include those imposed by the Statute of Frauds, where applicable, legal capacity on the part of each of the parties, and legality. “Legal capacity” refers to a person's (or corporate entity's) authority under law to engage in a particular undertaking. “Legality” refers to the subject matter of the contract. For example, contracts regarding the sale of illegal drugs are unenforceable, as are contracts for loans that impose usurious interest rates on borrowers.

An offer is a promise or commitment to act or refrain from acting in a specified way. A number of expressions border on, but are not, promises. The most important of these in the context of electronic commerce is an invitation to make an offer. RFPs/RFQs as discussed above are merely invitations to make offers, rather than binding offers themselves.

An offer can be accepted by any person in whom the power of acceptance is created, as determined by the “reasonable person” standard. Because the offeror is the master of her/his offer, s/he controls the person(s) in whom a power of acceptance may be created. For example, a reward offer may ordinarily be accepted by anyone who knows of the offer, but once the offer is accepted, no one else may accept. Essentially, the language of the offer determines to whom it is offered and who may accept it. Thus, by wording an offer appropriately, it can be directed to a number of persons but capable of acceptance by only one.

“Consideration”, the third of the three basic elements of contract formation, refers to the benefit that a party gives to other in order to induce the other into a contract. In a contract, one party's consideration is exchanged for the other's. Examples include the payment of an agreed sum of money for a particular product, and a particular product delivered upon receipt of payment of the agreed sum. Gratuitous promises are not enforced.

In some cases, the Statute of Frauds requires that a party produce a written copy of the contract. The primary purpose of this rule is to avoid perjury, and the result is the result is that oral contracts concerning subject matter subject (e.g., contracts for the sale of real property) to the rule are often unenforceable.

An electronic data interchange (EDI) allows one party to transfer information and legally relevant “documents” electronically to another for direct processing in the other party's information systems. Today, contracts can be formed based on the exchange of only electronic information between the parties, provided that the minimal essentials for contract formation in the particular jurisdiction are satisfied. This is true in even automated exchanges in the absence of human decisions. To avoid problems that can exist where unauthorized people or inaccurate information triggers an “offer” in such a system, methods of attribution or authentication can be used. In electronic systems, since offers seldom if ever specify a method for acceptance, acceptance may be in any manner and by any medium reasonable under the circumstances. In the

In electronic commerce, an issue related to the Statute of Frauds concerns transactions that involve a sale of goods for more than or equal to a statutory amount (e.g., $500 or more). The Uniform Commercial Code, and its state law counterparts, requires: (1) a writing; (2) containing a quantity term; (3) sufficient to indicate that a contract has been made; (4) signed by the party against whom enforcement is sought. In electronic commerce, the “writing” requirement is typically satisfied electronic records sufficient to establish an intent to enter into and the terms of the contract, while party authentication satisfies the “signature” requirement. Indeed, authentication systems have been developed specifically to ensure the enforceability of electronic contracts, and many are known in the art, any of which can be for adapted for application in the context of this invention. Moreover, e-commerce systems that authenticate the terms and conditions of buyer offers are more likely to attract the attention of potential vendors, because they are assured of the legitimacy of the offer.

The invention also envisions a third party (or a combination of third parties) to administer the reverse auction system of the invention. The third party can act as an arbitrator available to resolve contract disputes between buyers and sellers, thereby increasing the parties' confidence in the system. Preferably dispute resolution approaches include mediation and arbitration, which can be specified in the buyer's purchase order generated by the e-commerce system hosting the reverse auction service. Additionally, the third party can establish standard protocols, formats, terms, and language to be used in buyers' purchase offers and thus make it easier for vendors to understand and assess offers. Finally, the third party can administer an Internet site that buyers can use to generate buyer purchase offers and vendors can go to participate in reverse auctions. In addition, the third party administering the system, or another third party, can notify one or more vendors specializing in particular types of trade item(s) (or bundles thereof) of upcoming or ongoing reverse auctions for such items. Centralizing such information and functionality makes it easier for buyers and sellers to participate in reverse auctions.

The inventor is unaware of the existence of any e-commerce system that employs features described herein.

### 3. The Invention

The present invention concerns a business model that allows a buyer to optimize the terms of, particularly the purchase price for, a particular a new good or service the buyer wishes to acquire. The invention employs a financially committed buyer-directed reverse auction, the primary objective of which is to drive purchase prices below a “ceiling price” set by the buyer (in some embodiments, with assistance from the system) upon consideration of pricing information available for the target trade item from one or more vendors. In contrast to a conventional “forward auction”, which allows a vendor to find the “best”, i.e., highest, price among two or more interested buyers, a reverse auction allows a buyer to find the lowest price vendor of the target trade item. Unlike traditional reverse auctions based on the RFP/RFQ process, however, where a buyer identifies a good or service s/he wishes to purchase and then solicits sales offers from multiple sellers, after which the buyer accepts the most favorable offer, the instant invention involves a financially committed buyer who desires to buy a target trade item by extending a legally binding purchase offer to two or more vendors, preferably accredited vendors, to buy the target trade item (i.e., a target product (e.g., a consumer product) or service identified by a buyer) at a price determined by a dynamic, preferably online or Internet-based, bidding process, provided that the lowest auction-determined price is equal to or less than a ceiling price established by the buyer prior to initiating the reverse auction.

During a reverse auction according to the invention, each participating (i.e., bidding) vendor submits at least one proffered acceptance. In many cases, the winning vendor may submit multiple proffered acceptances, typically in response to competing vendors' proffered acceptances, in an effort with “win” the auction, i.e., become the vendor who will deliver the target trade item to the buyer and who will receive payment therefore in the amount determined by the auction. As will be appreciated, this process bids down the ultimate sales price of the target trade item, with each vendor ultimately proffering acceptance based on the lowest price it is willing to sell the particular good or service for. By revealing the competing bids, or at least the proffered acceptance with the then lowest proffered sales price, in real time to each participating (preferably accredited) vendor, preferably via a web-based graphical user interface, this open process promotes price transparency. Even so, the invention also includes “closed” embodiments where each participating vendor submits one proffered acceptance that is “sealed”, i.e., not revealed to the other participating vendors during the auction period.

As will be appreciated, the invention allows a consumer to purchase a particular desired good or service (or bundles of specific goods and/or services) for no more than, and frequently for less than, the ceiling price designated by the consumer. This serves to not only to increase the effective purchasing power of consumers (by allowing them to pay less than they otherwise would for a particular trade item, leaving them more money for other purchases and uses), but also to increase customer satisfaction, as the consumer will be less likely to believe or feel that s/he overpaid for a good or service when that trade item was purchased at or below the customer's ceiling price, or maximum price the customer felt comfortable in paying for the target good(s) and/or service(s). As explained in more detail below, there are different embodiments of the invention, including whether the bidding process is “open” (i.e., vendors may repeatedly bid and are aware of each other's previous bids) or “closed” (i.e., sellers submit sealed bids), what price is used to initiate the auction and how that price is selected, whether there is a “reserve” (i.e., a “ceiling” price above which the consumer is unwilling to pay), the length of the auction period and whether it may be extended, whether the identities of participating vendors are revealed, whether the identity of the buyer is revealed, whether there are limits on or minimum increments between bid prices in proffered acceptances, how the winning proffered acceptance is determined, etc.

Thus, one object of the invention is to allow a vendor willing to attempt to meet the terms of a buyer purchase offer for one or more trade items specified in the purchase offer to make a bid during a reverse auction in an effort to bind the buyer to accept the vendor's fulfillment of that offer at the conclusion of the auction.

Another object of the invention is to allow the vendor to be able to collect funds immediately upon the closing of a reverse auction, provided that the vendor won the auction by providing the most favorable terms to the buyer that were in compliance with the buyer's purchase order. In some embodiments, this may involve the vendor receiving a portion of the buyer's committed funds upon closing of the auction, and a subsequent payment upon delivery and/or acceptance of the trade item(s) specified in the buyer's purchase offer.

A further object of the invention allows for a third-party administrator whose decision regarding the fulfillment, adequacy, or interpretation of any aspect of the reverse auction process shall be binding on the buyer and vendor. Preferably, the third-party administrator hosts an e-commerce platform configured to provide the functionality require to initiate, run, and conclude (by termination or closure) of a reverse auction as described herein. In some embodiments, either buyers or sellers can to remain anonymous up until such time as an agreement is consummated. Moreover, in some such embodiments, the buyer can opt to remain anonymous even after closure of successful reverse auction by using a third-party administrator system configured to maintain buyer anonymity.

In preferred embodiments, the third-party administrator provides an e-commerce (or other secure) system in which the identity of any buyer is authenticated along with the integrity of the buyer's purchase offer, including commitment of buyer funds equal to or more than the buyer-established reserve or ceiling price.

In other preferred embodiments, the third-party administrator provides an e-commerce (or other secure) system in which each vendor invited or allowed to participate in a reverse auction is authenticated or accredited in order to ensure such vendor's capacity to satisfy the conditions of the particular buyer purchase offer and deliver the trade item(s) purchased pursuant to a successful reverse auction.

In a preferred embodiment, the present invention provides a method and system for prospective buyers of goods or services to communicate a binding purchase offer globally to potential sellers, one or more of whom may then elect to participate in a reverse auction in an attempt to win the auction by agreeing to at least meet the term of the buyer's purchase offer and thereby contractually bind the buyer to a contract based on the buyer's purchase offer. Additionally, the present invention can effectuate performance of the contract between the buyer and seller by guaranteeing buyer payment for the purchase, should the auction close. As such, the invention provides a patentable, highly effective buyer-driven commerce system that gives buyers the power to take advantage of ever-increasing amounts of publicly available pricing information, empowering them to achieve more favorable and satisfying purchase transactions than possible using conventional retail product and services sales channels. It also allows buyers to reach vendors capable of satisfying their purchasing needs on their terms, as well as providing vendors additional opportunities to make marginal sales.

In preferred embodiments of this invention, communications between a buyer and one or more vendors take place using an electronic network and a central controller. A buyer who wishes to make a purchase of a particular trade item accesses a central controller located at a remote server. The buyer then creates a buyer purchase offer by specifying at least one item descriptor for a target product or service a buyer wishes to acquire, most commonly by purchase, and a ceiling purchase price for the target product or service. The item descriptor (e.g., manufacturer name and catalog and/or SKU [stock keeping unit] number) allows the target product or service to be distinguished from non-target products or services. The ceiling price, which need not be disclosed to vendors, can be specified by the buyer directly, automatically (e.g., by a computer-based search for the lowest price, which is then approved by the buyer; could also provide for an incremental reduction, say 5-10%), or by reference to a free or fee-or-subscription based product/service pricing information database maintained by the third party administrator or other third party. In some embodiments, for example, a buyer may specify a buyer's ceiling price after consulting pricing information for the trade item(s) sought to be purchased provided by the third party administrator's e-commerce system. In some embodiments, a buyer's ceiling price is a price higher than a buyer-defined SELL IT NOW™ price, if a SELL IT NOW™ feature is included as an option in the reverse auction.

The buyer then inputs into the system buyer payment information to enable the system to generate payment indicator, which buyer payment information includes a funding source for payment of the ceiling price if a closing of a reverse auction corresponding to the buyer's purchase order occurs for the target product or service. The system then obtains from the funding source a payment indicator evidencing irrevocable availability of funds associated with the buyer in an amount sufficient to pay the ceiling purchase price if a closing of the reverse auction occurs. The buyer can input information using any suitable approach, including entering data through a world-wide-web graphical user interface, electronic mail, text message, voice mail, facsimile, postal mail, or by voice telephony. The system then integrates such user provided information with standard legal provisions suitable to generate a legally sufficient purchase offer for the desired target item(s).

After gathering information necessary to generate a buyer purchase offer over the course of one or more data gathering sessions, the e-commerce system preferably authenticates the buyer's information using any suitable method. The third party administrator's e-commerce platform also preferably manages the payment system between the buyer and vendor automatically. Any suitable payment method can be utilized, including credit cards, PayPal® account, personal checks, electronic funds transfer, debit cards, digital cash, and, in some embodiments, even bartering. The e-commerce platform preferably automatically confirms that the buyer has sufficient credit or funds available to cover the ceiling price specified in the buyer purchase order by contacting, for example, a credit card clearinghouse. In preferred embodiments, the payment system involves the use of an escrow account associated with the buyer wherein funds (in at least the amount of the buyer's ceiling price) advanced by the buyer to cover the purchase of a target item can be kept pending the closing of the corresponding reverse auction. If the closing does not occur, the funds held in escrow can be refunded to the buyer's account, should the buyer so direct. Moreover, the payment system allows the timing of payment to the seller can be varied following an auction's closure. For example, the seller may be paid in full immediately upon closure, or some portion of the payment can be delayed until after the seller performs her/his/its obligations under the contract.

Upon receipt of the payment indicator or otherwise confirming that payment can be made if the corresponding reverse auction closes, the system prompts the buyer regarding initiating a reverse auction in order to gather the information necessary to conduct the auction, including auction start time, auction period, restrictions, if any, on potential vendors (e.g., geographic, business type [e.g., minority-owned, Green-certified, etc.], and such other information as is necessary to conduct a reverse auction on the system. Auction periods can be of suitable duration, for example, from about 1-72 hours, about 1-60 days, or about 1-6 months. Auction period duration can depend on many factors, including the type of target item sought to be purchased (with more expensive products and services typically having longer auction periods), the number of potential vendors, etc. Of course, the system may include one or more default auction periods for a buyer to select from, or the buyer may be afforded the option to specify its own period.

After gathering the requisite information, the e-commerce system generates an auction identifier for identification of the particular reverse auction corresponding to the buyer purchase order and payment indicator, in addition to performing any other functions necessary to initiate and manage the auction in the system, including terminating, or, optionally extending, it upon expiry of the auction period if no vendor wins the auction or, alternatively, if a vendor wins the auction, to close it, including arranging for payment to the vendor and delivery of the target item(s) to the buyer.

After initiating the auction, the e-commerce system contacts at least one, and preferably many more than one, vendors known or believed to stock or have access to inventory that includes the target item(s) to inform the vendor(s) of the auction and to invite them to participate. Contact may be electronic (e.g., by email, text message, etc.), by telephone, or in person. Contact is preferably made with accredited vendors.

If, after reviewing a particular buyer purchase offer, a prospective vendor wishes to participate in the particular reverse auction, the vendor may do so by communicating its intent to the system. The system then records and timestamps the message from the vendor. The system authenticates the identity of the vendor and its capacity to deliver the target item(s) sought by the buyer. If the buyer requires or desires that the vendor(s) participating in the auction be accredited, the system also performs an accreditation step. The system then verifies that the particular buyer purchase offer is still “active” (i.e., has not been canceled or replaced) and capable of being accepted. If a particular buyer purchase offer is still capable of being accepted, it is accepted if and only if one or more prospective, optionally accredited, vendors accept the purchase offer by proffering terms, including a bid price, that is(are) equal to or less than the ceiling or reserve price during the auction period. In that event that there is only one prospective vendor who meets or betters the terms listed in the buyer's purchase offer, that vendor wins the auction. If at the end of the auction period two or more vendors accept the buyer's purchase offer by proffering terms equal to or more favorable to the buyer than those listed in the in the buyer's purchase offer, the vendor that proffered the terms most favorable to the buyer wins the auction. In some cases, the auction period may be extended.

At the end of a reverse auction according to this invention that is won by a vendor, the auction is closed, the price proffered by the winning vendor that constitutes acceptance of the buyer's purchase offer is fixed as the final sales price, and the system notifies the corresponding vendor and buyer that vendor has accepted the buyer's purchase offer, thereby forming a legally binding contract that requires the vendor to be paid and the target (item(s) to be provided to the buyer in accordance with the terms of the buyer's purchase offer. The final sales price may include sales tax, shipping and delivery charges, insurance, extended warranties and/or service plans, etc. Alternatively, a webpage showing the auction's status may include advertizing, links to other products/services (complementary or not), offers for extended warranties and/or service plans, shipping/delivery/insurance options, etc.

In some embodiments, the vendor(s) that participated in the reverse auction but did not win are so notified. Such notice may or may not include disclosure of the final sales price. If disclosed, the system may require a losing vendor to pay a fee for access to the final sales price information.

In those reverse auction embodiments that provide for a SELL IT NOW™ price, a vendor can win the auction, cause its auction term to be truncated, and the auction to close by accepting the SELL IT NOW™ price designated in the buyer's purchase offer. In such event the final sales price will be the SELL IT NOW™ price, plus any taxes, fees, or other charges referenced in the buyer's purchase offer.

At the end of the auction period of any auction, regardless of whether the auction closes or ends without a winning vendor, the system updates accordingly to reflect the end of the auction, and stores such information as the system is configured to collect. For those auctions that close, a unique tracking number is preferably assigned to the vendor's bid that resulted in acceptance and winning of the auction. That acceptance, and such other information about the auction that the system is configured to collect and retain, is then stored in a database associated with the system.

In some embodiments, cryptographic protocols are used to authenticate the identity of buyers and/or vendors and to verify the integrity of buyer and vendor communications with the e-commerce platform. Using cryptography and preferably biometrics, the system can make it significantly more difficult for unauthorized persons to tamper with or gain access to the system by passing themselves off as legitimate buyers or vendors or by eavesdropping on system communications.

Anonymity is another feature that may be utilized in practicing the present invention. For numerous privacy and competitive reasons, buyers and vendors often prefer not to have their identities revealed to the general public when engaging in commercial transactions. The present invention can be adapted to provide for and preserve the anonymity of buyers and vendors through the use of any suitable method, including the use of identification numbers stored in a database secured by the system.

Other embodiments of the present invention do not require a transfer of money from a buyer to a vendor. For example, in a barter transaction, the buyer posts the product(s) and/or service(s) it is willing to exchange for the trade item(s) is wishes to acquire, and the vendor binds the buyer by agreeing to accept those product(s) and/or service(s) in exchange for the trade item(s) the buyer wishes to acquire from the vendor.

In some embodiments, the system allows buyers and/or vendors to rate or post comments regarding the counterparty to a transaction in which it was a party.

The following illustrate several preferred approaches regarding various features of the invention.

Selecting Products: For example, the REDLASER app:

Mobile device applications, such as are used on smartphones (e.g., Apple Inc.'s iPhone®), are available that allow a consumer to take a picture of or directly use a laser to scan a barcode, QR code, or the like on a label affixed to a product of interest. Such applications use the photo (or, alternatively, use a laser scanner to directly scan a barcode) and from it identify the product and then use Internet-based shopping or price comparison applications such as GOOGLE, The Find, etc. to obtain and present to the consumer via the mobile device's display screen price information for that product at various vendors located within a certain distance of mobile device (and consumer). One example of such an application is RedLaser (eBay Inc.). RedLaser is a mobile device-based barcode-scanning application for comparison shopping and finding product information. RedLaser's barcode scanning technology is compatible with non-autofocus cameras found in many currently available smartphones and other mobile devices. A consumer can use an app such as RedLaser to select a target product and determine the ceiling price to be used in a reverse auction according to the invention, which are preferably conducted online, over the Internet.

Determining the Buyer's Ceiling Price:

One step in this process preferably involves establishing a trade item purchase price. The trade item purchase price may be lower, but is preferably higher than the ceiling price, in which event the ceiling price acts as a reserve price, meaning that unless bidding gets down to the ceiling price or lower, there will not be a closing. A “reserve” auction is an auction where the item the buyer wishes to acquire (by purchase, lease, etc.) may not be sold if the final bid is not low enough to satisfy the buyer; that is, the buyer “reserves” the right to accept or reject the lowest bid, provided it is not equal to or less than the reserve set by the buyer before the auction began. Here, the “reserve” price is known to the buyer and e-commerce system (which may, if agreed by the buyer, may be configured to accept a bid near the “reserve” price, e.g., not more than about 10%, preferably not more than about 5%, 4%, 3%, 2%, 1%, or more than the “reserve” price; i.e., a “flexible reserve” price), but not necessarily to the bidding sellers. As described, the reserve price can be fixed or flexible, as determined by the buyer. In the latter case, whether a bid is can be accepted as a winning bid is determined by parameters established by the buyer in setting up the reverse auction. As will be appreciated, a reverse auction with a reserve price will be safer for the buyer than a no-reserve reverse auction, as the buyer will not be required to accept a bid above the reserve price, but this could result in no purchase being consummated at the end of the auction period.

In order to achieve the most favorable outcome for the buyer, namely the lowest possible final sales price, a reverse auction will have many proffered acceptances placed by at least several (preferably accredited) vendors. To achieve this, the opening bid, or starting purchase price, for a reverse auction according to the invention, namely the “product/service purchase price”, preferably is higher than the buyer's ceiling price for the target trade item. For example, the product/service purchase price could be established as the median, or average, price for the product observed using an online price comparison application such as PRICEGRABBER™ (PriceGrabber, Inc., Los Angeles, Calif.) or Google Products. Such a relatively high opening price, higher than the lowest advertized price that can be readily identified, for example, online, for the target trade item, will promote interest among vendors interested in participating in the particular reverse auction. Experience with forward auctions reveals that final sales prices rise as the numbers of bidders rise. Also, when there are many bids in a forward auction, most are low, and only a few are high, and without several low bids there will not be any high bids. By analogy, in a reverse auction it is preferred that the auction period open with several bids quickly being made. By setting the opening sales price within a range where any winning vendor might achieve a high sales margin, multiple vendors will have an incentive to participate. As proffered selling prices fall during the bidding process, the number of participating vendors will likely decrease, and the bidding rate is also likely to decline, although it is not uncommon in the context of online forward auctions for the bidding rate to accelerate as the end of the auction period draws near. Similar results should occur for many reverse auctions as those prospective vendors participating in the bidding process near the end of the auction period have an incentive to win the auction in order to achieve a marginal sale and monetize its investment made in participation in the auction.

Avoiding Collusion Among Vendors and Other Problems:

Whenever some or all of the vendors participating in a reverse auction know the identity of at least one other participating vendor, there exists a risk of collusion (i.e., working together to prevent or reduce downward price pressure during the bidding process, often by agreeing to bid only against other vendors not known to any of the colluding vendors) among vendors. To minimize or eliminate this risk, in preferred embodiments, the actual identity of any vendor, accredited or otherwise, is not disclosed during the bidding process. Vendor anonymity can be accomplished, for example, by randomly assigning each vendor a different number or other identification symbol.

In order to maintain the integrity of the reverse auction process, in preferred embodiments the terms of the reverse auction will provide that only accredited vendors can participate, and that no dummy bids are permitted which, if used, could deceive genuine participating accredited vendors into proffering acceptances with selling prices lower than they would have otherwise provided.

All of the inventions described and claimed herein can be made and executed without undue experimentation in light of the specification. The terms and expressions which have been employed herein to described the invention are used as terms of description and not of limitation, and there is no intention that in the use of such terms and expressions of excluding any equivalents of the features shown and described or portions thereof, but it is recognized that various modifications are possible within the scope of the invention claimed. Also, while the inventions have been described in terms of preferred embodiments, it will be apparent to those of skill in the art that variations may be applied without departing from the spirit and scope of the invention as claimed herein. All such variations and equivalents apparent to those skilled in the art, whether now existing or later developed, are deemed to be within the spirit and scope of the invention as defined by the appended claims.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms.

All patents, patent applications, and publications mentioned in the specification are indicative of the levels of those of ordinary skill in the art to which the invention pertains. All patents, patent applications, and publications are herein incorporated by reference in their entirety for all purposes and to the same extent as if each individual publication was specifically and individually indicated to be incorporated by reference in its entirety for any and all purposes.

I claim:

1. A computer-based reverse auction method, comprising:
a. inputting into a computer a purchase order that comprises at least one item descriptor for a target product or service a buyer wishes to purchase, wherein the item descriptor(s) allows the target product or service to be distinguished from non-target products or services, and a ceiling purchase price for the target product or service;
b. providing a payment indicator evidencing irrevocable availability of funds associated with the buyer in an amount sufficient to pay the ceiling purchase price if a closing occurs for a reverse auction corresponding to the purchase order;
c. obtaining an auction identifier for identification of a reverse auction corresponding to the purchase order and payment indicator;
d. after obtaining the auction identifier, using the computer to initiate a reverse auction having a defined auction period (optionally 1-72 hours, 1-60 days, or 1-6 months) by transmitting a buyer's purchase offer to and soliciting acceptance thereof from at least one prospective seller, optionally an accredited seller, of the target product or service during the auction period, wherein the buyer's purchase offer comprises at least one of the item descriptors and a product/service purchase price equal to or less than the ceiling purchase price, and wherein acceptance of the buyer's purchase offer comprises a prospective seller of the target product or service providing during the auction period a selling price equal to or less than the product/service purchase price; and
e. if (X) no prospective, optionally accredited, seller accepts the buyer's purchase offer during the auction period, terminating the auction; (Y) one prospective, optionally accredited, seller accepts the buyer's purchase offer during the auction period, closing the auction at the conclusion of the auction period, fixing as the final sales price the selling price for the target product or service, and awarding the sale of the target product or service to such optionally accredited seller; or (Z) more than one prospective, optionally accredited seller, accepts the buyer's purchase offer during the auction period, closing the auction at the conclusion of the auction period, awarding the sale of the target product or service to the prospective, optionally accredited, seller that first accepted during the auction period the buyer's purchase offer on terms most favorable to the buyer, and fixing as the final sales price the selling price provided by the optionally accredited seller awarded the sale.

2. A method according to claim 1 that, if there is a closing of the reverse auction, further comprises at least one of the following:
a. informing the buyer thereof, and optionally further comprising informing the buyer of the final sales price;
b. facilitating the seller's collection of payment of the final sales price for the target product or service; and/or
c. facilitating delivery or provision of the target product or service to the buyer.

3. A method according to claim 1 wherein a seller's acceptance of the buyer's purchase offer further comprises an agreement to deliver the target product or service upon receipt of payment equal to the final sales price.

4. A method according to claim 1 wherein if no prospective seller accepts the initial buyer's purchase offer during the auction period, prior to terminating the auction, extending the auction period for an additional defined period if approved by the buyer and informing the prospective seller(s) from whom acceptance was earlier solicited of such extension.

5. A method according to claim 4 wherein extension of the auction period comprises extending the purchase order and/or the buyer's purchase offer.

6. A method according to claim 4 wherein if no prospective seller accepts the buyer's purchase offer during the auction period, replacing the buyer's purchase offer then in effect with a revised purchase offer comprising a revised product/service purchase price greater than the product/service purchase price to be replaced but equal to or less than the ceiling purchase price.

7. A method according to claim 1 wherein the buyer's purchase offer further comprises a “SELL IT NOW” price that is less than the ceiling price, wherein if a prospective seller accepts the buyer's purchase offer by agreeing during the auction period to sell the target product or service to the buyer at the “SELL IT NOW” price, closing the auction prior to conclusion of the auction period, fixing the “SELL IT NOW” price as a final sales price, and awarding the sale to such accredited seller.

8. A method according to claim 1 wherein when more than one prospective seller accepts the buyer's purchase offer during the auction period, prior to closing the auction at the conclusion of the auction period, (A) informing the prospective sellers of at least the lowest selling price then provided in the corresponding acceptances and allowing the prospective sellers to downwardly revise their respective selling prices, if desired, or (B) informing every prospective seller other than the prospective seller with the lowest selling price that another prospective seller participating in the reverse auction has provided a selling price less than such seller's respective selling price and allowing the prospective seller(s) so informed to downwardly revise their respective selling prices, if desired, during the auction period.

9. A method according to claim 8 wherein if a prospective seller downwardly revises its selling price such that at the conclusion of the auction period it first accepted the buyer's purchase offer on terms most favorable to the buyer, closing the auction, awarding the sale to such prospective seller, and fixing as the final sales price the downwardly revised selling price provided by such prospective seller.

10. A computer system, comprising in operable association:
a. a processor configured to execute computer control logic to perform a reverse auction in accordance with the method of claim 1;
b. an interface that allows receipt of information (R) required to complete a buyer's purchase order for a target product or service and (S) required to complete an optionally accredited seller's acceptance of the buyer's purchase offer;
c. one or more storage devices for storing (T) data at least some of which is received through the first and/or second input device(s) and (U) at least some of the computer control logic used to perform the reverse auction; and
e. a power supply.
